(19) United States
(12) Patent Application Publication
(10) Pub. No.: US 2009/0186253 A1
(43) Pub. Date: Jul. 23, 2009

(54) Bipolar Plate Design for Passive Low Load Stability

(75) Inventors: Thomas A. Trabold, Pittsford, NY (US); Steven R. Falta, Honeoye Falls, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/016,014

(22) Filed: Jan. 17, 2008

(51) Int. Cl. H01M 8/02

(52) U.S. Cl. 429/34

(57) ABSTRACT

A fuel cell that includes a flow field plate having flow channels, where the flow channels include one enlarged stability flow channel for each set of a predetermined number of smaller flow channels. The stability channel provides a higher volume of flow therethrough, which prevents the accumulation of water at low loads.

### BACKGROUND OF THE INVENTION

1. Field of the Invention

This invention relates generally to a flow field plate for a fuel cell stack and, more particularly, to a flow field plate for a fuel cell stack, where the flow field plate includes at least one expanded flow channel so as to prevent water blockage in the expanded channel at low stack loads.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid-polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Several fuel cells are typically combined in a fuel cell stack to generate the desired power. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack. The bipolar plates include an anode side and a cathode side for adjacent fuel cells in the stack. Anode gas flow channels are provided on the anode side of the bipolar plates that allow the anode gas to flow to the anode side of each MEA. Cathode gas flow channels are provided on the cathode side of the bipolar plates that allow the cathode gas to flow to the cathode side of each MEA. The bipolar plates are made of a conductive material, such as stainless steel, so that they conduct the electricity generated by the fuel cells from one cell to the next cell as well as out of the stack. The bipolar plates also include flow channels through which a cooling fluid flows.

FIG. 1 is a cross-sectional view of a fuel cell 10 of the type discussed above. The fuel cell 10 includes a cathode side 12 and an anode side 14 separated by an electrolyte membrane 16. A cathode side diffusion media layer 20 is provided at the cathode side 12, and a cathode side catalyst layer 22 is provided between the membrane 16 and the diffusion media layer 20. Likewise, an anode side diffusion media layer 24 is provided at the anode side 14, and an anode catalyst layer 26 is provided between the membrane 16 and the diffusion media layer 24. The catalyst layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 20 and 24, respectively, or on the membrane 16.

A cathode side flow field or bipolar plate 18 is provided on the cathode side 12 and an anode side flow field or bipolar plate 30 is provided on the anode side 14. The bipolar plates 18 and 30 are positioned between the fuel cells in a fuel cell stack, as is well known in the art. A hydrogen gas flow 28 from parallel flow channels (not shown in FIG. 1) in the bipolar plate 30 reacts with the catalyst layer 26 to dissociate the hydrogen ions and the electrons. Airflow 36 from parallel flow channels (not shown in FIG. 1) in the bipolar plate 18 reacts with the catalyst layer 22. The hydrogen ions are able to propagate through the membrane 16 where they electro-chemically react with the airflow 36 and the return electrons in the catalyst layer 22 to generate water.

FIG. 2 is a partial cross-sectional view of the cathode side bipolar plate 18. The bipolar plate 18 is made of a metal, such as stainless steel or a carbon composite material, and includes flow channels 50 formed between lands 52 through which the airflow 36 is provided to the cathode side 12 of the fuel cell 10. The flow channels 50 are parallel channels extending between an inlet manifold and an outlet manifold (not shown).

Current fuel cell stack designs typically focus on achieving high volumetric power density by reducing the active area of the fuel cell and increasing the current density. The key enabling design features of the bipolar plate 18 for this purpose include elimination of serpentine flow channels on the cathode side 12 to avoid accumulation of liquid water in the U-bends of the channels 50, and the reduction of the channel-to-channel pitch to maximize the utilization of the catalyst layer 22 under the lands 52 in the absence of a significant channel-to-channel pressure gradient. In this design, the cathode side bipolar plate 18 includes 108 nearly rectangular channels 50 with a width of 0.55 mm and a depth of 0.29 mm and a land width of 0.65 mm. These flow field plates provide operation above 600 mV at 1.5 A/cm². One example of such a flow field plate is disclosed in U.S. patent application Ser. No. 10/669,479, titled Flow Field Plate Arrangement For A Fuel Cell, filed Sep. 24, 2003.

Some flow field plate designs lack voltage stability at low loads (<0.4 A/cm²) where the gas velocities are relatively low. Under conditions where liquid water is present in the fuel cell stack, the water can form “slugs” that extend across the entire channel cross-section and starve the downstream active area of the membrane of oxygen.

It has been observed that the voltage stability of the individual fuel cells, and a spread of the voltages in a multi-cell stack is largely dictated by the velocity of the cathode airflow. It has also been observed that the voltage stability improves as the gas velocity approaches about 5 m/s. This trend may be related to the transition in two-phase flow regime from a slug to an annular flow. In the latter case, the liquid is transported in thin films along the channel walls. Hence, differences in liquid volume between adjacent channels result in small differences in flow resistance, and therefore the flow split between channels is not greatly affected. Two-phase flow data for small non-circular channels demonstrates that the transition from the slug to the annular flow regime for very low liquid volumetric fluxes (superficial velocity) occurs in the range of 4 to 6 m/s.

It has been shown that the lack of operational stability in this fuel cell stack design is due to water accumulation in one or more of the fuel cells. Infrared images from a stack flash frozen under low load instability conditions has shown that in some fuel cells there was liquid water throughout a large area of the cathode and anode flow field bipolar plates. For the lowest performing cell, slugs of water were present in all of the cathode channels except one. The cell with the next lowest voltage had much less total water, but still most cathode channels have at least one slug filling the entire cross-section. Additionally, it has been found that under certain fuel cell operating conditions water accumulation in the anode side flow channels also negatively impacts cell performance.

### SUMMARY OF THE INVENTION

In accordance with the teachings of the present invention, a fuel cell is disclosed that includes a bipolar plate having flow channels, where the flow channels include one enlarged stability flow channel for each set of a predetermined number of smaller flow channels. The stability channel provides a higher volume of flow therethrough, which prevents the accumulation of water at low loads. In one embodiment, one stability flow channel is provided for every ten smaller flow channels.

Additional advantages and features of the present invention will become apparent from the following description and appended claims, taken in conjunction with the accompanying drawings.

### BRIEF DESCRIPTION OF THE DRAWINGS

FIG. 1 is a cross-sectional plan view of a fuel cell in a fuel cell stack of the type known in the art;

FIG. 2 is a partial cross-sectional view of a cathode side flow field plate known in the art;

FIG. 3 is a graph with a fraction of blocked cathode channels on the horizontal axis and cell voltage on the vertical axis showing the relationship between the cell voltage and cathode channel blockage during a load low instability event;

FIG. 4 is a partial cross-sectional view of a cathode side flow field plate including flow channels, according to an embodiment of the present invention; and

FIG. 5 is a partial cross-sectional view of a cathode side flow field plate including flow channels, according to another embodiment of the present invention.

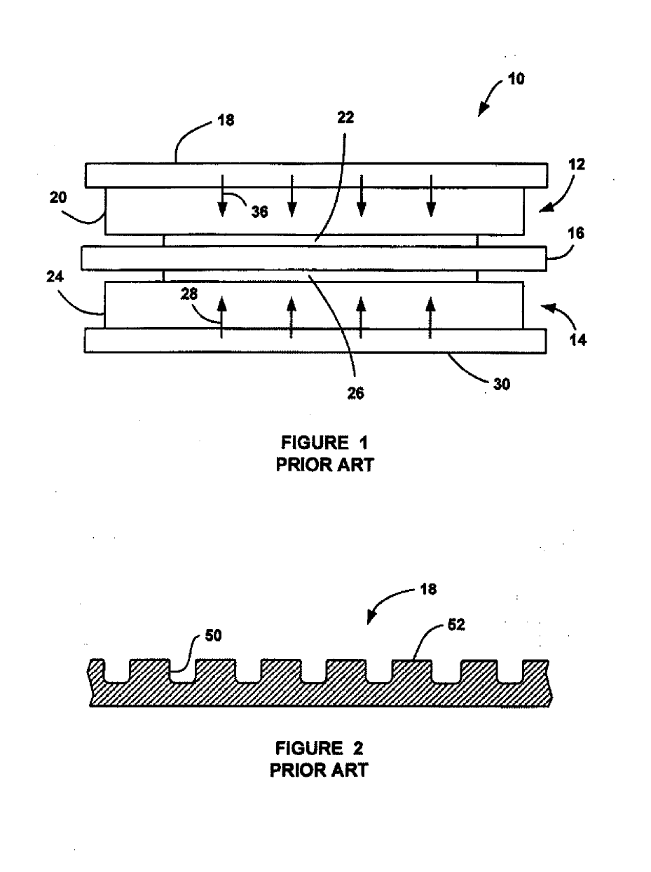

### DETAILED DISCUSSION OF THE EMBODIMENTS

The following discussion of the embodiments of the invention directed to providing one or more enlarged flow channels in a flow field plate associated with a fuel cell is merely exemplary in nature, and is in no way intended to limit the invention or its applications or uses.

The present invention proposes altering the flow field plate geometry of a flow field plate to provide a small number of “stability channels” that will stay free of water even when all other channels in the flow field may be blocked. This can be accomplished by increasing the size of these stability channels to support a proportionally higher gas volumetric flow.

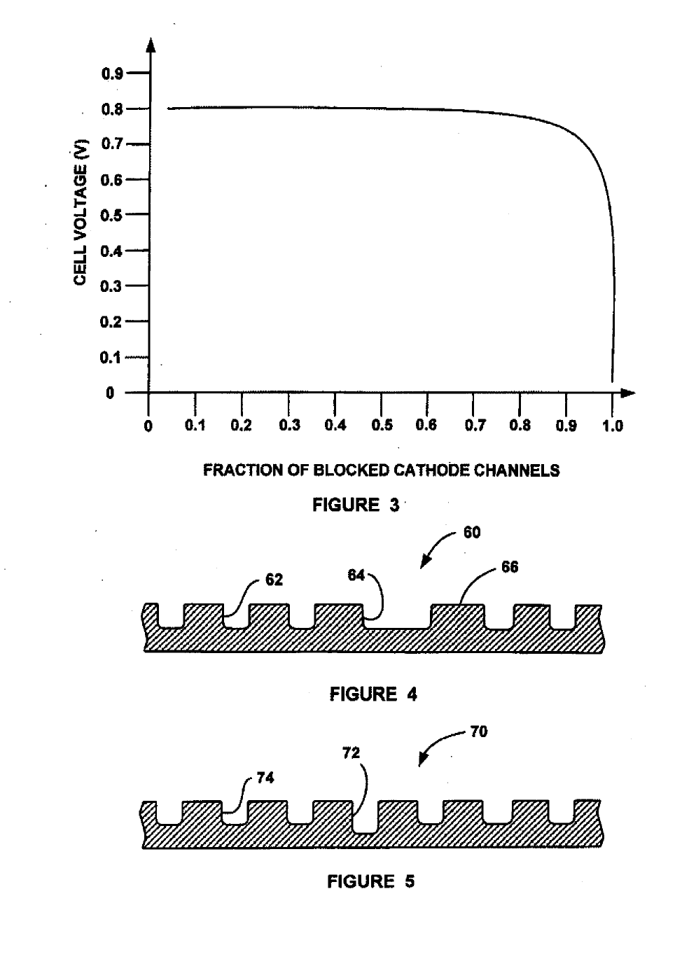

FIG. 3 is a graph with fraction of blocked cathode channels on the horizontal axis and cell voltage on the vertical axis showing the relationship between the cell voltage and the cathode channel blockage during a low load instability event. FIG. 3 shows that there is a correlation between the cell voltage and the fraction of cathode channels blocked with water. Although it is not known definitely if the water migrated between the diffusion media layer and the flow field plates, the underlying observation was that water accumulation on the cathode side was the primary cause of instability at low load. Further, FIG. 3 shows that significant voltage degradation occurs only when a large fraction of the cathode channels (>85%) are blocked with water. Therefore, it is proposed that improved operational stability at low loads can be attained by providing flow paths over only a small fraction of the active area that stay open under conditions for which a large amount of liquid water is present.

In order to illustrate the invention, consider the case of five identical flow channels connected to a common inlet and outlet manifold. Because all of the channels have the same pressure drop, the flow is equally split between the channels. Now consider the case where the center channel of the five channels is wider and/or deeper so that its hydraulic diameter Dₕ is larger than that of the other four channels by a factor β. This gives:

$$\begin{matrix}{D}_{h , 1} = {D}_{h , 2} = \frac{1}{β} {D}_{h , 3} = {D}_{h , 4} = {D}_{h , 5} & ( 1 ) \\ Δ {P}_{1} = Δ {P}_{2} = Δ {P}_{3} = Δ {P}_{4} = Δ {P}_{5} & ( 2 )\end{matrix}$$

For each channel, the pressure drop is related to the mean gas velocity by the relation:

$$Δ P = 2 f \frac{L}{{D}_{h}} ρ {V}^{2} \qquad ( 3 )$$

In equation (3), f is the friction factor, L is the channel length, ρ is the fluid density and V is the mean gas velocity. Even for channels of different size, the pressure drop is uniform, and therefore, for channels of the same length:

$$2 {f}_{1} \frac{L}{{D}_{h , 1}} ρ {V}_{1}^{2} = 2 {f}_{3} \frac{L}{{D}_{h , 3}} ρ {V}_{3}^{2} \qquad ( 4 )$$

Rearranging equation (4) gives:

$$\frac{{f}_{1} {D}_{h , 3}}{{f}_{3} {D}_{h , 1}} = \frac{{V}_{3}^{2}}{{V}_{1}^{2}} \qquad ( 5 )$$

It is known that the channel Reynolds number for current flow field designs is much less than 1000. For a laminar flow, the friction factor can be represented by:

$$f = \frac{16}{Re} = \frac{16 μ}{ρ {D}_{h} V} \qquad ( 6 )$$

In equation (6), Re is the Reynolds number and μ is the fluid viscosity.

Substituting equation (6) into equation (5) gives:

$$\frac{{V}_{3}}{{V}_{1}} = \frac{{D}_{3}^{2}}{{D}_{1}^{2}} = {β}^{2} \qquad ( 7 )$$

Therefore, by equation (7), to double the velocity in the center stability channel, it is necessary that the hydraulic diameter in this channel be increased by \sqrt{2}, or about 41%. Although this illustrated example is provided for the simple case of five co-flowing channels, it is apparent that the same approach can be applied to any number of channels connected to common inlet and outlet manifolds.

The present invention proposes providing a subset of larger flow field channels or stability channels for better operational stability. The invention is further illustrated by considering situations involving channel water accumulation. This condition may arise during cold start-up where water vapor condensation occurs prior to when the fuel cell stack reaches its full operating temperature, or during transient operations where the relative humidity temporarily exceeds 100%. Consider a single water droplet filling the entire cross-section of a horizontal flow field channel. If it assumed that the surface properties of the flow field and the diffusion media layer are the same, then at the onset of the droplet motion, the pressure force across the slug is balanced by the surface tension force as:

ΔPA=γp(cos θ_{R}−cos θ_{A}) (8)

In equation (8), A is the channel cross-sectional area, γ is the water surface tension, p is the channel perimeter and θ_{R} and θ_{A} are the receding and advancing contact angles, respectively. The surface tension and contact angles are material properties and are constant across the channels. Therefore, the pressure gradient required to move a stagnant liquid slug varies as the ratio of the channel perimeter to cross-sectional area. For a given cross-sectional geometry, this ratio becomes small as the channel is made larger. Further, it can be shown that a differential pressure ratio between the stability channel and a standard channel varies inversely to the parameter β. For the case where the stability channel has twice the velocity of the standard channel, the pressure to move a water slug is about 70%, i.e., 1/\sqrt{2} of the standard channel.

In order to aid in the design of the stability channel of the invention, it is beneficial to relate the dimensions of a standard channel to those of the stability channel. This relationship can be derived from any channel geometry/shape using equation (1) above in a definition of a hydraulic diameter, i.e., channel cross-sectional area/wetted parameter as:

D_{h,3}=β·D_{h,4} (9)

For the case of rectangular flow channels, the following expression is derived:

$$wr = \frac{β \cdot dr \cdot AR}{( ( 1 + AR ) \cdot dr - β )} \qquad ( 10 )$$

Where the width ratio of a stable channel to a standard channel is:

$$wr = \frac{{w}_{3}}{{w}_{1}} \qquad ( 11 )$$

The depth ratio of a stable channel to a standard channel is:

$$dr = \frac{{d}_{3}}{{d}_{1}} \qquad ( 12 )$$

The aspect ratio of a standard channel is:

$$AR = \frac{{d}_{1}}{{w}_{1}} \qquad ( 13 )$$

For a given channel shape there is a specific relation between depth and width for a specified β. For the case of a rectangular channel, the ranges can be 0.7<wr<2 and 1<dr<2. Note that a width increase is not a requirement to achieve a larger channel and increased velocity. Other channel shapes, such as triangular or semicircular, should fall within the ranges chosen. However, this will limit the velocity increase of the stability channel.

From a design standpoint, packaging constraints may limit the depth ratio to 2, and limitations on channel intrusion of diffusion media could limit the width ratio to 2. Therefore, the range in width ratio could be 0.7-2, and the depth ratio could be in the range of 1-2, possibly larger, if packaging allows.

FIG. 4 is a partial cross-sectional view of a cathode side flow field plate 60 that can replace the flow field plate 18 in the fuel cell 10, according to one embodiment of the present invention. The flow field plate 60 includes flow channels 62 separated by lands 66 and including a center stability channel 64 of the type discussed above. According to one embodiment, about 15% of the channels 62 are stability channels. In this design, there is one of the stability channels 64 for each group of ten smaller channels 62. However, this is by way of a non-limiting example. Further, in this design, by providing the enlarged stability channel 64, the total number of the channels 62 is reduced, but the total flow through the channels 62 is about the same.

The stability channel 64 has a suitable width beyond the width of the other channels 62 so that the stability channel 64 will not be blocked by a water slug during low load conditions, for example, loads at least as low 0.02 A/cm². However, this increased width cannot be so great as to cause the diffusion media layer to intrude into the channel 64. In one embodiment, there are 108 of the channels 62, where each of the stability channels 64 is 30-50% wider than the other channels 62, and particularly 41% wider.

FIG. 5 is a partial cross-sectional view of a cathode side flow field plate 70 that can replace the flow field plate 18 in the fuel cell 10, according to another embodiment of the present invention. In this embodiment, the flow field plate 70 includes a stability channel 72 that is deeper than the other flow channels 74 so as to provide the increased flow velocity and prevent water accumulation in the stability channel 72 at low loads consistent with the discussion above.

The discussion above refers to the flow field plates 60 and 70 as being cathode side flow field plates. However, it has also been observed that under certain fuel cell operating conditions water accumulation occurs in the anode side flow field channels, resulting in degraded fuel cell performance. Therefore, according to another embodiment of the present invention, the flow field plates 60 and 70 can be anode side flow field plates, where the stability channels 64 and 72 prevent water accumulation in the anode side flow channels. In this embodiment, an increased flow of hydrogen, or reformate produced by processing a hydrogen feedstock, is provided through a part of the fuel cell active area, thereby further improving water management and operational stability at low fuel cell loads.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell comprising:
a membrane; and
a flow field plate positioned proximate to the membrane, said flow field plate including a plurality of parallel flow channels responsive to a gas for delivering the gas to the membrane, wherein a plurality of the plurality of flow channels have a predetermined size and at least one of the plurality of flow channels is a stability channel having a larger size than the predetermined size.

2. The fuel cell according to claim 1 wherein the flow field plate is a cathode side flow field plate where the flow channels are responsive to air.

3. The fuel cell according to claim 1 wherein the flow field plate is a anode side flow field plate where the flow channels are responsive to hydrogen or a hydrogen reformate.

4. The fuel cell according to claim 1 wherein the at least one stability channel is one stability channel for every ten other channels.

5. The fuel cell according to claim 1 wherein the at least one stability channel is wider than the other channels.

6. The fuel cell according to claim 5 wherein the width of the stability channel is 30-50% wider than the other channels.

7. The fuel cell according to claim 5 wherein the width of the stability channel is about 41% wider than the other channels.

8. The fuel cell according to claim 1 wherein the at least one stability channel is deeper than the other channels.

9. The fuel cell according to claim 1 wherein the size of the at least one stability channel is large enough to effectively prevent water accumulation in the stability channel at fuel cell loads at least as low as 0.02 A/cm².

10. The fuel cell according to claim 1 wherein the number of stability channels is about 15% of the total number of channels.

11. The fuel cell according to claim 1 wherein the fuel cell is part of a fuel cell stack on a vehicle.

12. A fuel cell comprising:
a membrane; and
a flow field plate positioned proximate to the membrane, said flow field plate including a plurality of parallel flow channels responsive to a flow for delivering the flow to the membrane, wherein a plurality of the plurality of flow channels have a predetermined width and at least one of the plurality of flow channels is a stability channel having a width greater than the width of the plurality of plurality of flow channels, and wherein the width of the at least one stability channel is wide enough to effectively prevent water accumulation in the stability channel at fuel cell loads at least as low as 0.02 A/cm².

13. The fuel cell according to claim 12 wherein the at least one stability channel is one stability channel for every ten other channels.

14. The fuel cell according to claim 12 wherein the width of the stability channel is 30-50% wider than the other channels.

15. The fuel cell according to claim 14 wherein the width of the stability channel is about 41% wider than the other channels.

16. The fuel cell according to claim 12 wherein the number of stability channels is about 15% of the total number of channels.

17. The fuel cell according to claim 12 wherein the fuel cell is part of a fuel cell stack on a vehicle.

18. A fuel cell that is part of a fuel cell stack on a vehicle, said fuel cell comprising:
a membrane; and
a flow field plate positioned proximate to the membrane, said flow field plate including a plurality of parallel flow channels responsive to a flow for delivering the flow to the membrane, wherein a plurality of the plurality of flow channels have a predetermined width and one out of ten of the flow channels is a stability channel having a width greater than the width of the plurality of plurality of flow channels, and wherein the width of the stability channels is wide enough to effectively prevent water accumulation in the stability channels at fuel cell loads at least as low as 0.02 A/cm².

19. The fuel cell according to claim 18 wherein the width of the stability channels is 30-50% wider than the other channels.

20. The fuel cell according to claim 19 wherein the width of the stability channels is about 41% wider than the other channels.
